(19) United States
(12) Patent Application Publication
(10) Pub. No.: US 2025/0215157 A1
(43) Pub. Date: Jul. 3, 2025

(54) COMPOSITE MATERIAL, COMPOSITE MATERIAL LAYER, AND CELL VENT PROTECTION COMPOSITE WITH THERMAL BARRIER PROPERTIES

(71) Applicant: SAINT-GOBAIN PERFORMANCE PLASTICS CORPORATION, Solon, OH (US)

(72) Inventors: Shifang ZHAO, Shanghai City (CN); Yangdi LI, Shanghai (CN)

(21) Appl. No.: 18/989,265

(22) Filed: Dec. 20, 2024

Related U.S. Application Data
(60) Provisional application No. 63/627,501, filed on Jan. 31, 2024.

(30) Foreign Application Priority Data
Dec. 29, 2023 (CN) 202311861302.3

(51) Int. Cl. C08G 77/08; C08G 77/12; C08G 77/20; C08J 9/06; H01M 10/658

(52) U.S. Cl. CPC C08G 77/08; C08G 77/12; C08G 77/20; C08J 9/06; H01M 10/658; C08J 2203/02; C08J 2203/04; C08J 2383/05; C08J 2383/07

(57) ABSTRACT

The subject application relates to composite material, composite material layer, and cell vent protection composite with thermal barrier properties. The subject application relates to a composite material that may include a silicone-based matrix component, a reinforcing filler component distributed within the silicone-based matrix component, and a ceramization filler composition distributed within the silicone-based matrix component. The ceramization filler composition may include a ceramization filler component, a structure promoter component, a flux component, and a flame retardant component.

### CROSS-REFERENCE TO RELATED APPLICATIONS

This Application claims priority to Chinese Patent Application No. 202311861302.3, filed Dec. 29, 2023, entitled “COMPOSITE MATERIAL, COMPOSITE MATERIAL LAYER, AND CELL VENT PROTECTION COMPOSITE WITH THERMAL BARRIER PROPERTIES,” by Shifang ZHAO et al., which is assigned to the current assignee hereof and incorporated herein by reference in its entirety. This application further claims priority under 35 U.S.C. § 119(e) to U.S. Provisional Patent Application No. 63/627,501, filed Jan. 31, 2024, entitled “COMPOSITE MATERIAL, COMPOSITE MATERIAL LAYER, AND CELL VENT PROTECTION COMPOSITE WITH THERMAL BARRIER PROPERTIES,” by Shifang ZHAO et al., which is assigned to the current assignee hereof and incorporated herein by reference in its entirety.

### FIELD OF THE DISCLOSURE

The present disclosure relates to a composite material, a composite material layer, and a cell vent protection composite, in particular, a composite material, a composite material layer, and a cell vent protection composite for use as a thermal barrier in various applications, for example, in a battery pack, and methods of forming the same.

### BACKGROUND

Filler compositions, composite materials, and composite material layers may be designed for high temperature protection in various applications, for example, for use as thermal barriers in electric vehicle battery packs, thermal barrier coverings in high temperature cable protection, thermal barrier containers for thermal spray containment, etc. However, in these, and in other applications, potential heat growth continues to increase due to improvements in technology. Accordingly, there is a continuing need for improved barrier designs that protect against such high heat potential.

### SUMMARY

According to a first aspect, a composite material may include a silicone-based matrix component, a reinforcing filler component distributed within the silicone-based matrix component, and a ceramization filler composition distributed within the silicone-based matrix component. The ceramization filler composition may include a ceramization filler component, a structure promoter component, a flux component, and a flame retardant component. The composite material may have a compression set of not greater than about 5% as measured at 50% compressive strain for 22 hours at 100° C.

According to still another aspect, a composite material layer may include a silicone-based matrix component, a reinforcing filler component distributed within the silicone-based matrix component, and a ceramization filler composition distributed within the silicone-based matrix component. The ceramization filler composition may include a ceramization filler component, a structure promoter component, a flux component, and a flame retardant component. The composite material layer may have a compression set of not greater than about 5% as measured at 50% compressive strain for 22 hours at 100° C.

According to yet another aspect, a cell vent protection composite material may include a composite material. The composite material may include a silicone-based matrix component, a reinforcing filler component distributed within the silicone-based matrix component, and a ceramization filler composition distributed within the silicone-based matrix component. The ceramization filler composition may include a ceramization filler component, a structure promoter component, a flux component, and a flame retardant component. The cell vent protection composite material may have a compression set of not greater than about 5% as measured at 50% compressive strain for 22 hours at 100° C.

According to still another aspect, a cell vent protection composite material may include a composite material layer. The composite material layer may include a silicone-based matrix component, a reinforcing filler component distributed within the silicone-based matrix component, and a ceramization filler composition distributed within the silicone-based matrix component. The ceramization filler composition may include a ceramization filler component, a structure promoter component, a flux component, and a flame retardant component. The cell vent protection composite material may have a compression set of not greater than about 5% as measured at 50% compressive strain for 22 hours at 100° C.

### BRIEF DESCRIPTION OF THE DRAWINGS

Embodiments are illustrated by way of example and are not limited to the accompanying figures.

FIG. 1 includes an illustration of an example composite material according to certain embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present), and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a composite material that may include a silicone-based matrix component, a reinforcing filler component distributed within the silicone-based matrix component, and a ceramization filler composition distributed within the silicone-based matrix component.

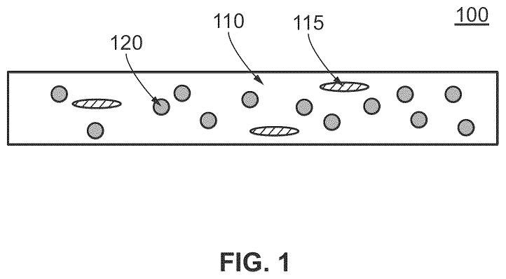

For purposes of illustration, FIG. 1 shows a composite material 100 according to embodiments described herein. As shown in FIG. 1, a composite material 100 may include a silicone-based matrix component 110, a reinforcing filler component 115, and a ceramization filler composition 120 distributed within the silicone-based matrix component 110.

According to particular embodiments, the silicone-based matrix component 110 of the composite material 100 may include a particular material. For example, the silicone-based matrix component 110 may include silicone. According to yet other embodiments, the silicone-based matrix component 110 may consist of silicone.

According to yet other embodiments, the silicone-based matrix component 110 may include a polydimethylsiloxane gum having an average molecule weight between 300,000 and 800,000, or a liquid polydimethylsiloxane polymer having a viscosity of between 50 cst and 100,000 cst. According to yet other embodiments, the silicone-based matrix component 110 may include a vinyl and Si-hydrogen group which can react with each other in the presence of a platinum catalyst.

According to still other embodiments, the composite material 100 may include a particular content of the silicone-based matrix component 110. For example, the composite material 100 may include a silicone-based matrix component content of at least about 30 wt. % for a total weight of the composite material 100, such as, at least about 33 wt. % or at least about 35 wt. % or at least about 38 wt. % or at least about 40 wt. % or at least about 43 wt. % or at least about 45 wt. % or even at least about 48 wt. %. According to still other embodiments, the composite material 100 may include a silicone-based matrix component content of not greater than about 60 wt. % for a total weight of the composite material 100, such as, not greater than about 58 wt. % or not greater than about 55 wt. % or not greater than about 53 wt. % or even not greater than about 50 wt. %. It will be appreciated that composite material 100 may include a silicone-based matrix component content of any value within a range between any of the minimum and maximum values noted above. It will be further appreciated that the composite material 100 may include a silicone-based matrix component content of any value between any of the minimum and maximum values noted above.

According to yet other embodiments, the reinforcing filler component 115 of the composite material 100 may include a particular material. For example, the reinforcing filler component 115 may include silica, silicone resin, carbon black, calcium carbonate, or any combination thereof. According to still other embodiments, the reinforcing filler component 115 may consist of silica, silicone resin, carbon black, calcium carbonate, or any combination thereof.

According to still other embodiments, the composite material 100 may include a particular content of the reinforcing filler component 115. For example, the composite material 100 may include a reinforcing filler component content of at least about 2.0 wt. % for a total weight of the composite material 100, such as, at least about 4.0 wt. % or at least about 6.0 wt. % or at least about 8.0 wt. % or at least about 10.0 wt. % or at least about 12.0 wt. % or at least about 14.0 wt. % or even at least about 16.0 wt. %. According to still other embodiments, the composite material 100 may include a reinforcing filler component content of not greater than about 20 wt. % for a total weight of the composite material 100, such as, not greater than about 19 wt. % or not greater than about 18 wt. % or even not greater than about 17 wt. %. It will be appreciated that composite material 100 may include a reinforcing filler component content of any value within a range between any of the minimum and maximum values noted above. It will be further appreciated that the composite material 100 may include a reinforcing filler component content of any value between any of the minimum and maximum values noted above.

According to still other embodiments, the composite material 100 may include a particular content of the ceramization filler composition 120. For example, the composite material 100 may include a ceramization filler composition content of at least about 40 wt. % for a total weight of the composite material 100, such as, at least about 43 wt. % or at least about 45 wt. % or at least about 48 wt. % or at least about 50 wt. % or at least about 53 wt. % or at least about 55 wt. % or even at least about 58 wt. %. According to still other embodiments, the composite material 100 may include a ceramization filler composition content of not greater than about 70 wt. % for a total weight of the composite material 100, such as, not greater than about 68 wt. % or not greater than about 65 wt. % or not greater than about 63 wt. % or even not greater than about 60 wt. %. It will be appreciated that composite material 100 may include a ceramization filler composition content of any value within a range between any of the minimum and maximum values noted above. It will be further appreciated that the composite material 100 may include a ceramization filler composition content of any value between any of the minimum and maximum values noted above.

According to certain embodiments, the ceramization filler composition 120 may include a ceramization filler component, a structure promoter component, a flux component, and a flame retardant component.

According to particular embodiments, the ceramization filler component of the ceramization filler composition 120 may include particular components. For example, the ceramization filler component may include a component selected from the group consisting of sepiolite, wollastonite, or any combination thereof. According to still other embodiments, the ceramization filler component may include sepiolite. According to yet other embodiments, the ceramization filler component may consist of sepiolite. According to still other embodiments, the ceramization filler component may include wollastonite. According to yet other embodiments, the ceramization filler component may consist of wollastonite. According to still other embodiments, the ceramization filler component may include a combination of sepiolite and wollastonite. According to yet other embodiments, the ceramization filler component may consist of a combination of sepiolite and wollastonite.

According to still other embodiments, the ceramization filler component of the ceramization filler composition 120 may be a plurality of particles. According to still other embodiments, the ceramization filler component may have a particular aspect ratio. For purposes of embodiments described herein the aspect ratio of the ceramization filler component may be defined as the average length of a statistically significant number of the plurality of particles of the ceramization filler component divided by the average diameter of a statistically significant number of plurality of particles of the ceramization filler component (L/D). For example, the ceramization filler component may have an aspect ratio of not greater than about 10.0, such as, not greater than about 9.5 or not greater than about 9.0 or not greater than about 8.5 or not greater than about 8.0 or not greater than about 7.5 or not greater than about 7.0 or not greater than about 6.5 or not greater than about 6.0 or even not greater than about 5.5. According to still other embodiments, the ceramization filler component may have an aspect ratio of at least about 2.0, such as, at least about 2.5 or at least about 3.0 or at least about 3.5 or at least about 4.0 or even at least about 4.5. It will be appreciated that the ceramization filler component may have an aspect ratio of any value within a range between any of the minimum and maximum values noted above. It will be further appreciated that the ceramization filler component may have an aspect ratio of any value between any of the minimum and maximum values noted above.

According to still other embodiments, the ceramization filler composition 120 may include a particular content of the ceramization filler component. For example, the ceramization filler composition 120 may include a ceramization filler component content of at least about 50 wt. % for a total weight of the ceramization filler composition 120, such as, at least about 55 wt. % or at least about 60 wt. % or at least about 65 wt. % or at least about 70 wt. % or at least about 75 wt. % or at least about 80 wt. % or at least about 81 wt. % or at least about 82 wt. % or at least about 83 wt. % or at least about 84 wt. % or even at least about 85 wt. %. According to still other embodiments, the ceramization filler composition 120 may include a ceramization filler component content of not greater than about 95 wt. % for a total weight of the ceramization filler composition 120, such as, not greater than about 94 wt. % or not greater than about 93 wt. % or not greater than about 92 wt. % or not greater than about 91 wt. % or not greater than about 90 wt. % or not greater than about 89 wt. % or not greater than about 88 wt. % or not greater than about 88 wt. % or even not greater than about 87 wt. %. It will be appreciated that the ceramization filler composition 120 may include a ceramization filler component content of any value within a range between any of the minimum and maximum values noted above. It will be further appreciated that the ceramization filler composition 120 may include a ceramization filler component content of any value between any of the minimum and maximum values noted above.

According to still other embodiments, the composite material 100 may include a particular content of the ceramization filler component. For example, the composite material 100 may include a ceramization filler component content of at least about 40 wt. % for a total weight of the composite material 100, such as, at least about 41 wt. % or at least about 42 wt. % or at least about 43 wt. % or at least about 44 wt. % or at least about 45 wt. % or at least about 46 wt. % or at least about 47 wt. % or at least about 48 wt. % or at least about 49 wt. % or at least about 50 wt. % or at least about 51 wt. % or at least about 52 wt. % or at least about 53 wt. % or at least about 54 wt. % or at least about 55 wt. % or at least about 56 wt. % or at least about 57 wt. % or at least about 58 wt. % or at least about 59 wt. % or even at least about 60 wt. %. According to still other embodiments, the composite material 100 may include a ceramization filler component content of not greater than about 70 wt. % for a total weight of the composite material 100, such as, not greater than about 69 wt. % or not greater than about 68 wt. % or not greater than about 67 wt. % or not greater than about 66 wt. % or not greater than about 65 wt. % or not greater than about 64 wt. % or not greater than about 63 wt. % or not greater than about 62 wt. % or not greater than about 61 wt. % or even not greater than about 60 wt. %. It will be appreciated that composite material 100 may include a ceramization filler component content of any value within a range between any of the minimum and maximum values noted above. It will be further appreciated that the composite material 100 may include a ceramization filler component content of any value between any of the minimum and maximum values noted above.

According to particular embodiments, the structure promoter component of the ceramization filler composition 120 may include particular components. For example, the structure promoter component may include a component selected from the group consisting of crystalline silica, diopside, spodumene, lepidolite, lithium carbonate, lithium hydroxide, or any combination thereof. According to still other embodiments, the structure promoter component may include crystalline silica. According to yet other embodiments, the structure promoter component may consist of crystalline silica. According to still other embodiments, the structure promoter component may include diopside. According to yet other embodiments, the structure promoter component may consist of diopside. According to still other embodiments, the structure promoter component may include spodumene. According to yet other embodiments, the structure promoter component may consist of spodumene. According to still other embodiments, the structure promoter component may include lepidolite. According to yet other embodiments, the structure promoter component may consist of lepidolite. According to still other embodiments, the structure promoter component may include lithium carbonate. According to yet other embodiments, the structure promoter component may consist of lithium carbonate. According to still other embodiments, the structure promoter component may include lithium hydroxide. According to yet other embodiments, the structure promoter component may consist of lithium hydroxide.

According to still other embodiments, the ceramization filler composition 120 may include a particular content of the structure promoter component. For example, the ceramization filler composition 120 may include a structure promoter component content of at least about 0.1 wt. % for a total weight of the ceramization filler composition 120, such as, at least about 0.5 wt. % or at least about 1.0 wt. % or at least about 1.5 wt. % or at least about 2.0 wt. % or at least about 2.5 wt. % or at least about 3.0 wt. % or even at least about 3.5 wt. %. According to still other embodiments, the ceramization filler composition 120 may include a structure promoter component content of not greater than about 7.0 wt. % for a total weight of the ceramization filler composition 120, such as, not greater than about 6.5 wt. % or not greater than about 6.0 wt. % or not greater than about 5.5 wt. % or not greater than about 5.0 wt. % or not greater than about 4.5 wt. % or even not greater than about 4.0 wt. %. It will be appreciated that the ceramization filler composition 120 may include a structure promoter component content of any value within a range between any of the minimum and maximum values noted above. It will be further appreciated that the ceramization filler composition 120 may include a structure promoter component content of any value between any of the minimum and maximum values noted above.

According to still other embodiments, the composite material 100 may include a particular content of the structure promoter component. For example, the composite material 100 may include a structure promoter component content of at least about 0.05 wt. % for a total weight of the composite material 100, such as, at least about 0.1 wt. % or at least about 0.5 wt. % or at least about 1.0 wt. % or at least about 1.5 wt. % or at least about 2.0 wt. % or even at least about 2.5 wt. %. According to still other embodiments, the composite material 100 may include a structure promoter component content of not greater than about 5.0 wt. % for a total weight of the composite material 100, such as, not greater than about 4.5 wt. % or not greater than about 4.0 wt. % or not greater than about 3.5 wt. % or even not greater than about 3.0 wt. %. It will be appreciated that composite material 100 may include a structure promoter component content of any value within a range between any of the minimum and maximum values noted above. It will be further appreciated that the composite material 100 may include a structure promoter component content of any value between any of the minimum and maximum values noted above.

According to particular embodiments, the flux component of the ceramization filler composition 120 may include particular components. For example, the flux component may include a component selected from the group consisting of low T glass frit, zinc oxide, zinc borate, antimony (III) oxide, bismuth (III) oxide, or any combination thereof. According to still other embodiments, the flux component may include low T glass frit. According to yet other embodiments, the flux component may consist of low T glass frit. According to still other embodiments, the flux component may include zinc oxide. According to yet other embodiments, the flux component may consist of zinc oxide. According to still other embodiments, the flux component may include zinc borate. According to yet other embodiments, the flux component may consist of zinc borate. According to still other embodiments, the flux component may include antimony (III) oxide. According to yet other embodiments, the flux component may consist of antimony (III) oxide. According to still other embodiments, the flux component may include bismuth (III) oxide. According to yet other embodiments, the flux component may consist of bismuth (III) oxide.

According to still other embodiments, the ceramization filler composition 120 may include a particular content of the flux component. For example, the ceramization filler composition 120 may include a flux component content of at least about 0.1 wt. % for a total weight of the ceramization filler composition 120, such as, at least about 0.5 wt. % or at least about 1.0 wt. % or at least about 1.5 wt. % or at least about 2.0 wt. % or at least about 2.5 wt. % or at least about 3.0 wt. % or even at least about 3.5 wt. %. According to still other embodiments, the ceramization filler composition 120 may include a flux component content of not greater than about 7.0 wt. % for a total weight of the ceramization filler composition 120, such as, not greater than about 6.5 wt. % or not greater than about 6.0 wt. % or not greater than about 5.5 wt. % or not greater than about 5.0 wt. % or not greater than about 4.5 wt. % or even not greater than about 4.0 wt. %. It will be appreciated that the ceramization filler composition 120 may include a flux component content of any value within a range between any of the minimum and maximum values noted above. It will be further appreciated that the ceramization filler composition 120 may include a flux component content of any value between any of the minimum and maximum values noted above.

According to still other embodiments, the composite material 100 may include a particular content of the flux component. For example, the composite material 100 may include a flux component content of at least about 0.01 wt. % for a total weight of the composite material 100, such as, at least about 0.05 wt. % or at least about 0.1 wt. % or at least about 0.5 wt. % or at least about 1.0 wt. % or at least about 1.5 wt. % or at least about 2.0 wt. % or even at least about 2.5 wt. %. According to still other embodiments, the composite material 100 may include a flux component content of not greater than about 5.0 wt. % for a total weight of the composite material 100, such as, not greater than about 4.5 wt. % or not greater than about 4.0 wt. % or not greater than about 3.5 wt. % or even not greater than about 3.0 wt. %. It will be appreciated that composite material 100 may include a flux component content of any value within a range between any of the minimum and maximum values noted above. It will be further appreciated that the composite material 100 may include a flux component content of any value between any of the minimum and maximum values noted above.

According to particular embodiments, the flame retardant component of the ceramization filler composition 120 may include particular components. For example, the flame retardant component may include a component selected from the group consisting of aluminum hydroxide, magnesium hydroxide, expanded graphite, a platinum (Pt) complex, or any combination thereof. According to still other embodiments, the flame retardant component may include aluminum hydroxide. According to yet other embodiments, the flame retardant component may consist of aluminum hydroxide. According to still other embodiments, the flame retardant component may include magnesium hydroxide. According to yet other embodiments, the flame retardant component may consist of magnesium hydroxide.

According to still other embodiments, the ceramization filler composition 120 may include a particular content of the flame retardant component. For example, the ceramization filler composition 120 may include a flame retardant component content of at least about 5.0 wt. % for a total weight of the ceramization filler composition 120, such as, at least about 6.0 wt. % or at least about 7.0 wt. % or at least about 8.0 wt. % or at least about 9.0 wt. % or at least about 10.0 wt. % or at least about 11.0 wt. % or even at least about 12.0 wt. %. According to still other embodiments, the ceramization filler composition 120 may include a flame retardant component content of not greater than about 20.0 wt. % for a total weight of the ceramization filler composition 120, such as, not greater than about 19.0 wt. % or not greater than about 18.0 wt. % or not greater than about 17.0 wt. % or not greater than about 16.0 wt. % or not greater than about 15.0 wt. % or even not greater than about 14.0 wt. %. According to still other embodiments, the ceramization filler composition 120 may include a flame retardant component content of at least about 4.0 ppm for a total weight of the ceramization filler composition 120, such as, at least about 6.0 ppm or at least about 10.0 ppm or at least about 20.0 ppm or at least about 30.0 ppm or at least about 40.0 ppm or at least about 50.0 ppm or even at least about 60.0 ppm. According to still other embodiments, the ceramization filler composition 120 may include a flame retardant component content of not greater than about 120 ppm for a total weight of the ceramization filler composition 120, such as, not greater than about 100.0 ppm or not greater than about 80.0 ppm or not greater than about 60.0 ppm or even not greater than about 40.0 ppm. It will be appreciated that the ceramization filler composition 120 may include a flame retardant component content of any value within a range between any of the minimum and maximum values noted above. It will be further appreciated that the ceramization filler composition 120 may include a flame retardant component content of any value between any of the minimum and maximum values noted above.

According to still other embodiments, the composite material 100 may include a particular content of the flame retardant component. For example, the composite material 100 may include a flame retardant component content of at least about 2.5 wt. % for a total weight of the composite material 100, such as, at least about 3.0 wt. % or at least about 3.5 wt. % or at least about 4.0 wt. % or at least about 4.5 wt. % or at least about 5.0 wt. % or at least about 5.5 wt. % or even at least about 6.0 wt. %. According to still other embodiments, the composite material 100 may include a flame retardant component content of not greater than about 10.0 wt. % for a total weight of the composite material 100, such as, not greater than about 9.5 wt. % or not greater than about 9.0 wt. % or not greater than about 8.5 wt. % or not greater than about 8.0 wt. % or not greater than about 7.5 wt. % or even not greater than about 7.0 wt. %. According to still other embodiments, the ceramization filler composition 120 may include a flame retardant component content of at least about 3.0 ppm for a total weight of the composite material 100, such as, at least about 6.0 ppm or at least about 10.0 ppm or at least about 15.0 ppm or at least about 20.0 ppm or at least about 25.0 ppm or at least about 30.0 ppm or even at least about 40.0 ppm. According to still other embodiments, the ceramization filler composition 120 may include a flame retardant component content of not greater than about 50.0 ppm for a total weight of the composite material 100, such as, not greater than about 40.0 ppm or not greater than about 30.0 ppm or not greater than about 25.0 ppm or even not greater than about 20.0 ppm. It will be appreciated that composite material 100 may include a flame retardant component content of any value within a range between any of the minimum and maximum values noted above. It will be further appreciated that the composite material 100 may include a flame retardant component content of any value between any of the minimum and maximum values noted above.

According to still other embodiments, the ceramization filler composition 120 may further include a functional additive. According to yet other embodiments, the functional additive may include a particular component. For example, the functional additive may include a component selected from the group consisting of iron (III) oxide, titanium oxide, or any combination thereof. According to still other embodiments, the functional additive component may include iron (III) oxide. According to yet other embodiments, the functional additive component may consist of iron (III) oxide. According to still other embodiments, the functional additive component may include titanium oxide. According to yet other embodiments, the functional additive component may consist of titanium oxide.

According to still other embodiments, the ceramization filler composition 120 may include a particular content of the functional additive. For example, the ceramization filler composition 120 may include a functional additive content of at least about 0.1 wt. % for a total weight of the ceramization filler composition 120, such as, at least about 0.5 wt. % or at least about 1.0 wt. % or at least about 1.5 wt. % or at least about 2.0 wt. % or at least about 2.5 wt. % or at least about 3.0 wt. % or even at least about 3.5 wt. %. According to still other embodiments, the ceramization filler composition 120 may include a functional additive content of not greater than about 7.0 wt. % for a total weight of the ceramization filler composition 120, such as, not greater than about 6.5 wt. % or not greater than about 6.0 wt. % or not greater than about 5.5 wt. % or not greater than about 5.0 wt. % or not greater than about 4.5 wt. % or even not greater than about 4.0 wt. %. It will be appreciated that the ceramization filler composition 120 may include a functional additive content of any value within a range between any of the minimum and maximum values noted above. It will be further appreciated that the ceramization filler composition 120 may include a functional additive content of any value between any of the minimum and maximum values noted above.

According to still other embodiments, the composite material 100 may include a particular content of the functional additive. For example, the composite material 100 may include a functional additive content of at least about 0.05 wt. % for a total weight of the composite material 100, such as, at least about 0.1 wt. % or at least about 0.5 wt. % or at least about 1.0 wt. % or at least about 1.5 wt. % or at least about 2.0 wt. % or even at least about 2.5 wt. %. According to still other embodiments, the composite material 100 may include a functional additive content of not greater than about 5.0 wt. % for a total weight of the composite material 100, such as, not greater than about 4.5 wt. % or not greater than about 4.0 wt. % or not greater than about 3.5 wt. % or even not greater than about 3.0 wt. %. It will be appreciated that composite material 100 may include a functional additive content of any value within a range between any of the minimum and maximum values noted above. It will be further appreciated that the composite material 100 may include a functional additive content of any value between any of the minimum and maximum values noted above.

According to yet other embodiments, the composite material 100 may further include a blowing agent component. According to certain embodiments, the blowing agent component of the composite material 100 may include a particular material. For example, the composite material 100 may be selected from the group consisting of 2,2′-Azobis(2-methylpropionitrile), N,N′-Dinitrosopentamethylenetetramine, N,N′-dimethyl-N,N′-dinitrosoterephthalamide, 4,4′-oxydibenzenesulfonyl hydrazide, sodium bicarbonate, and any combination thereof.

According to still other embodiments, the composite material 100 may include a particular content of the blowing agent component. For example, the composite material 100 may include a blowing agent component content of at least about 0.1 wt. % for a total weight of the composite material 100, such as, at least about 0.2 wt. % or at least about 0.3 wt. % or at least about 0.4 wt. % or at least about 0.5 wt. % or at least about 0.6 wt. % or at least about 0.7 wt. % or at least about 0.8 wt. % or at least about 0.9 wt. % or at least about 1.0 wt. % or at least about 1.5 wt. % or even at least about 2.0 wt. %. According to still other embodiments, the composite material 100 may include a blowing agent component content of not greater than about 5.0 wt. % for a total weight of the composite material 100, such as, not greater than about 4.9 wt. % or not greater than about 4.8 wt. % or not greater than about 4.7 wt. % or not greater than about 4.6 wt. % or not greater than about 4.5 wt. % or not greater than about 4.4 wt. % or not greater than about 4.3 wt. % or not greater than about 4.2 wt. % or not greater than about 4.1 wt. % or even not greater than about 4.0 wt. %. It will be appreciated that composite material 100 may include a blowing agent component content of any value within a range between any of the minimum and maximum values noted above. It will be further appreciated that the composite material 100 may include a blowing agent component content of any value between any of the minimum and maximum values noted above.

According to certain embodiments, the composite material 100 may have a particular flammability rating as measured according to ASTM D3801. In particular, the composite material 100 may have a V-0 flammability rating as measured according to ASTM D3801.

According to still other embodiments, the composite material 100 may have a particular 5-minute hot plate exposure (HPE) cold-side temperature as measured using a hot plate test conducted at 800° C. for 5 minutes. For purposes of embodiments described herein, the hot plate test is carried out by preparing a 15 cm by 25 cm specimen of the composite material laminated onto a layer of alkaline free glass fabric having a thickness of 0.3 mm, such that the total specimen thickness is 1.5 mm. The specimen is placed on top of a hot plate adjusted to the desired temperature with the composite material side of the specimen facing the hot plate. An infrared (IR) thermometer is used to measure the temperature at the central point of the cold side surface (i.e., the side of the specimen opposite the hot plate) of the sample at the designated time. According to certain embodiments, the composite material 100 may have a 5-minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material 100 may have a 5-minute HPE cold side temperature of at least about 25° C. It will be appreciated that the 5-minute HPE cold side temperature of the composite material 100 may be within a range between any of the values noted above. It will be further appreciated that the 5-minute HPE cold side temperature of the composite material 100 may be any value between any of the values noted above.

According to still other embodiments, the composite material 100 may have a particular 15-minute hot plate exposure (HPE) cold-side temperature as measured using a hot plate test conducted at 800° C. for 15 minutes. For purposes of embodiments described herein, the hot plate test is carried out by preparing a 15 cm by 25 cm specimen of the composite material laminated onto a layer of alkaline free glass fabric having a thickness of 0.3 mm, such that the total specimen thickness is 1.5 mm. The specimen is placed on top of a hot plate adjusted to the desired temperature with the composite material side of the specimen facing the hot plate. An infrared (IR) thermometer is used to measure the temperature at the central point of the cold side surface (i.e., the side of the specimen opposite the hot plate) of the sample at the designated time. According to certain embodiments, the composite material 100 may have a 15-minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material 100 may have a 15-minute HPE cold side temperature of at least about 25° C. It will be appreciated that the 15-minute HPE cold side temperature of the composite material 100 may be within a range between any of the values noted above. It will be further appreciated that the 15-minute HPE cold side temperature of the composite material 100 may be any value between any of the values noted above.

According to still other embodiments, the composite material 100 may have a particular 30-minute hot plate exposure (HPE) cold-side temperature as measured using a hot plate test conducted at 800° C. for 30 minutes. For purposes of embodiments described herein, the hot plate test is carried out by preparing a 15 cm by 25 cm specimen of the composite material laminated onto a layer of alkaline free glass fabric having a thickness of 0.3 mm, such that the total specimen thickness is 1.5 mm. The specimen is placed on top of a hot plate adjusted to the desired temperature with the composite material side of the specimen facing the hot plate. An infrared (IR) thermometer is used to measure the temperature at the central point of the cold side surface (i.e., the side of the specimen opposite the hot plate) of the sample at the designated time. According to certain embodiments, the composite material 100 may have a 30-minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material 100 may have a 30-minute HPE cold side temperature of at least about 25° C. It will be appreciated that the 30-minute HPE cold side temperature of the composite material 100 may be within a range between any of the values noted above. It will be further appreciated that the 30-minute HPE cold side temperature of the composite material 100 may be any value between any of the values noted above.

According to still other embodiments, the composite material 100 may have a particular 5-minute torch exposure (TE) cold-side temperature as measured using a torch test conducted at 1300° C. for 5 minutes with the material or composite material layer overlying a layer of glass fiber having a thickness of 100 microns. For purposes of embodiments described herein, the torch test is carried out by preparing a 15 cm by 15 cm specimen of the composite material laminated onto a layer of alkaline free glass fabric having a thickness of 100 microns, such that the total specimen thickness is 1.5 mm. The specimen is fixed on a holder. A torch is placed 7 cm away from a face of the specimen fixed on the holder with the composite material side of the specimen facing the torch. The torch is adjusted to produce an outer flame just touching the central point of the composite material side of the specimen that reaches and is stabilized at a desired temperature as measured using a thermometer at a point where the flame touches the specimen. An infrared (IR) thermometer or a thermocouple is used to measure the temperature at the central point of the cold side surface (i.e., the side of the specimen opposite the torch) of the sample at the designated time. According to certain embodiments, the composite material 100 may have a 5-minute TE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material 100 may have a 5-minute TE cold side temperature of at least about 25° C. It will be appreciated that the 5-minute TE cold side temperature of the composite material 100 may be within a range between any of the values noted above. It will be further appreciated that the 5-minute TE cold side temperature of the composite material 100 may be any value between any of the values noted above.

According to still other embodiments, the composite material 100 may have a particular 15-minute torch exposure (TE) cold-side temperature as measured using a torch test conducted at 1300° C. for 15 minutes with the material or composite material layer overlying a layer of glass fiber having a thickness of 100 microns. For purposes of embodiments described herein, the torch test is carried out by preparing a 15 cm by 15 cm specimen of the composite material laminated onto a layer of alkaline free glass fabric having a thickness of 100 microns, such that the total specimen thickness is 1.5 mm. The specimen is fixed on a holder. A torch is placed 7 cm away from a face of the specimen fixed on the holder with the composite material side of the specimen facing the torch. The torch is adjusted to produce an outer flame just touching the central point of the composite material side of the specimen that reaches and is stabilized at a desired temperature as measured using a thermometer at a point where the flame touches the specimen. An infrared (IR) thermometer or a thermocouple is used to measure the temperature at the central point of the cold side surface (i.e., the side of the specimen opposite the torch) of the sample at the designated time. According to certain embodiments, the composite material 100 may have a 15-minute TE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material 100 may have a 15-minute TE cold side temperature of at least about 25° C. It will be appreciated that the 15-minute TE cold side temperature of the composite material 100 may be within a range between any of the values noted above. It will be further appreciated that the 15-minute TE cold side temperature of the composite material 100 may be any value between any of the values noted above.

According to still other embodiments, the composite material 100 may have a particular 30-minute torch exposure (TE) cold-side temperature as measured using a torch test conducted at 1300° C. for 30 minutes with the material or composite material layer overlying a layer of glass fiber having a thickness of 100 microns. For purposes of embodiments described herein, the torch test is carried out by preparing a 15 cm by 15 cm specimen of the composite material laminated onto a layer of alkaline free glass fabric having a thickness of 100 microns, such that the total specimen thickness is 1.5 mm. The specimen is fixed on a holder. A torch is placed 7 cm away from a face of the specimen fixed on the holder with the composite material side of the specimen facing the torch. The torch is adjusted to produce an outer flame just touching the central point of the composite material side of the specimen that reaches and is stabilized at a desired temperature as measured using a thermometer at a point where the flame touches the specimen. An infrared (IR) thermometer or a thermocouple is used to measure the temperature at the central point of the cold side surface (i.e., the side of the specimen opposite the torch) of the sample at the designated time. According to certain embodiments, the composite material 100 may have a 30-minute TE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material 100 may have a 30-minute TE cold side temperature of at least about 25° C. It will be appreciated that the 30-minute TE cold side temperature of the composite material 100 may be within a range between any of the values noted above. It will be further appreciated that the 30-minute TE cold side temperature of the composite material 100 may be any value between any of the values noted above.

According to yet other embodiments, the composite material 100 may have a particular density. For the purpose of embodiments described herein, the density of the composite material 100 may be determined according to ASTM D1056. According to certain embodiments, the composite material 100 may have a density of not greater than about 1700 kg/m³, such as, not greater than about 1600 kg/m³ or not greater than about 1500 kg/m³ or not greater than about 1400 kg/m³ or not greater than about 1300 kg/m³ or not greater than about 1200 kg/m³ or not greater than about 1100 kg/m³ or not greater than about 1000 kg/m³ or not greater than about 900 kg/m³ or not greater than about 800 kg/m³ or not greater than about 700 kg/m³ or not greater than about 600 kg/m³ or not greater than about 500 kg/m³ or even not greater than about 400 kg/m³. According to yet other embodiments, the composite material 100 may have a density of at least about 200 kg/m³. It will be appreciated that the density of the composite material 100 may be within a range between any of the minimum and maximum values noted above. It will be further appreciated that the density of the composite material 100 may be any value between any of the minimum and maximum values noted above.

According to yet other embodiments, the composite material 100 may have a particular weight. According to certain embodiments, the composite material 100 may have a weight of at least about 0.04 kg/m², such as, at least about 0.1 kg/m² or at least about 0.2 kg/m² or at least about 0.3 kg/m² or at least about 0.4 kg/m² or at least about 0.5 kg/m² or at least about 1.0 kg/m² or even at least about 1.5 kg/m². According to yet other embodiments, the composite material 100 may have a weight of not greater than about 17 kg/m². It will be appreciated that the weight of the composite material 100 may be within a range between any of the minimum and maximum values noted above. It will be further appreciated that the weight of the composite material 100 may be any value between any of the minimum and maximum values noted above.

According to yet other embodiments, the composite material 100 may have a particular hardness. For the purpose of embodiments described herein, the hardness of the composite material 100 may be determined according to ASTM D2240. According to certain embodiments, the composite material 100 may have a hardness of at least about 20 Shore. 00, such as, at least about 22 Shore. 00 or at least about 23 Shore. 00 or at least about 24 Shore. 00 or even at least about 25 Shore. 00. According to yet other embodiments, the composite material 100 may have a hardness of not greater than about 71 Shore A, such as, not greater than about 70 Shore A or not greater than about 69 Shore A or not greater than about 68 Shore A or not greater than about 67 Shore A or even not greater than about 66 Shore A. It will be appreciated that the hardness of the composite material 100 may be within a range between any of the minimum and maximum values noted above. It will be further appreciated that the hardness of the composite material 100 may be any value between any of the minimum and maximum values noted above.

According to yet other embodiments, the composite material 100 may have a particular tensile strength. For the purpose of embodiments described herein, the tensile strength of the composite material 100 may be determined according to ASTM D412. According to certain embodiments, the composite material 100 may have a tensile strength of at least about 0.3 MPa, such as, at least about 0.5 MPa or at least about 1.0 MPa or at least about 10 MPa or at least about 20 MPa or at least about 30 MPa or at least about 40 MPa or at least about 50 MPa or at least about 100 MPa or even at least about 150 MPa. According to yet other embodiments, the composite material 100 may have a tensile strength of not greater than about 500 MPa. It will be appreciated that the tensile strength of the composite material 100 may be within a range between any of the minimum and maximum values noted above. It will be further appreciated that the tensile strength of the composite material 100 may be any value between any of the minimum and maximum values noted above.

Referring now to embodiments of the composite material layer, the composite material described herein may be formed as a layer of material. It will be appreciated that according to particular embodiments, a composite material layer described herein may include any of the components described herein with reference to the composite material 100. It will be further appreciated that according to particular embodiments, a composite material layer described herein may have any of the characteristics described herein with reference to the composite material 100.

According to yet other embodiments, the composite material layer may have a particular thickness. For example, the composite material layer may have a thickness of at least about 0.2 mm, such as, at least about 0.5 mm or at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the composite material layer may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the composite material layer may be within a range between any of the minimum and maximum values noted above. It will be further appreciated that the thickness of the composite material layer may be any value between any of the minimum and maximum values noted above.

According to certain embodiments, the composite material layer may have a particular flammability rating as measured according to ASTM D3801. In particular, the composite material layer may have a V-0 flammability rating as measured according to ASTM D3801.

According to still other embodiments, the composite material layer may have a particular 5-minute hot plate exposure (HPE) cold-side temperature as measured using a hot plate test conducted at 800° C. for 5 minutes. For purposes of embodiments described herein, the hot plate test is carried out by preparing a 15 cm by 25 cm specimen of the composite material laminated onto a layer of alkaline free glass fabric having a thickness of 0.3 mm, such that the total specimen thickness is 1.5 mm. The specimen is placed on top of a hot plate adjusted to the desired temperature with the composite material side of the specimen facing the hot plate. An infrared (IR) thermometer is used to measure the temperature at the central point of the cold side surface (i.e., the side of the specimen opposite the hot plate) of the sample at the designated time. According to certain embodiments, the composite material layer may have a 5-minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material layer may have a 5-minute HPE cold side temperature of at least about 25° C. It will be appreciated that the 5-minute HPE cold side temperature of the composite material layer may be within a range between any of the values noted above. It will be further appreciated that the 5-minute HPE cold side temperature of the composite material layer may be any value between any of the values noted above.

According to still other embodiments, the composite material layer may have a particular 15-minute hot plate exposure (HPE) cold-side temperature as measured using a hot plate test conducted at 800° C. for 15 minutes. For purposes of embodiments described herein, the hot plate test is carried out by preparing a 15 cm by 25 cm specimen of the composite material laminated onto a layer of alkaline free glass fabric having a thickness of 0.3 mm, such that the total specimen thickness is 1.5 mm. The specimen is placed on top of a hot plate adjusted to the desired temperature with the composite material side of the specimen facing the hot plate. An infrared (IR) thermometer is used to measure the temperature at the central point of the cold side surface (i.e., the side of the specimen opposite the hot plate) of the sample at the designated time. According to certain embodiments, the composite material layer may have a 15-minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material layer may have a 15-minute HPE cold side temperature of at least about 25° C. It will be appreciated that the 15-minute HPE cold side temperature of the composite material layer may be within a range between any of the values noted above. It will be further appreciated that the 15-minute HPE cold side temperature of the composite material layer may be any value between any of the values noted above.

According to still other embodiments, the composite material layer may have a particular 30-minute hot plate exposure (HPE) cold-side temperature as measured using a hot plate test conducted at 800° C. for 30 minutes. For purposes of embodiments described herein, the hot plate test is carried out by preparing a 15 cm by 25 cm specimen of the composite material laminated onto a layer of alkaline free glass fabric having a thickness of 0.3 mm, such that the total specimen thickness is 1.5 mm. The specimen is placed on top of a hot plate adjusted to the desired temperature with the composite material side of the specimen facing the hot plate. An infrared (IR) thermometer is used to measure the temperature at the central point of the cold side surface (i.e., the side of the specimen opposite the hot plate) of the sample at the designated time. According to certain embodiments, the composite material layer may have a 30-minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material layer may have a 30-minute HPE cold side temperature of at least about 25° C. It will be appreciated that the 30-minute HPE cold side temperature of the composite material layer may be within a range between any of the values noted above. It will be further appreciated that the 30-minute HPE cold side temperature of the composite material layer may be any value between any of the values noted above.

According to still other embodiments, the composite material layer may have a particular 5-minute torch exposure (TE) cold-side temperature as measured using a torch test conducted at 1300° C. for 5 minutes with the material or composite material layer overlying a layer of glass fiber having a thickness of 100 microns. For purposes of embodiments described herein, the torch test is carried out by preparing a 15 cm by 15 cm specimen of the composite material laminated onto a layer of alkaline free glass fabric having a thickness of 100 microns, such that the total specimen thickness is 1.5 mm. The specimen is fixed on a holder. A torch is placed 7 cm away from a face of the specimen fixed on the holder with the composite material side of the specimen facing the torch. The torch is adjusted to produce an outer flame just touching the central point of the composite material side of the specimen that reaches and is stabilized at a desired temperature as measured using a thermometer at a point where the flame touches the specimen. An infrared (IR) thermometer or a thermocouple is used to measure the temperature at the central point of the cold side surface (i.e., the side of the specimen opposite the torch) of the sample at the designated time. According to certain embodiments, the composite material layer may have a 5-minute TE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material layer may have a 5-minute TE cold side temperature of at least about 25° C. It will be appreciated that the 5-minute TE cold side temperature of the composite material layer may be within a range between any of the values noted above. It will be further appreciated that the 5-minute TE cold side temperature of the composite material layer may be any value between any of the values noted above.

According to still other embodiments, the composite material layer may have a particular 15-minute torch exposure (TE) cold-side temperature as measured using a torch test conducted at 1300° C. for 15 minutes with the material or composite material layer overlying a layer of glass fiber having a thickness of 100 microns. For purposes of embodiments described herein, the torch test is carried out by preparing a 15 cm by 15 cm specimen of the composite material laminated onto a layer of alkaline free glass fabric having a thickness of 100 microns, such that the total specimen thickness is 1.5 mm. The specimen is fixed on a holder. A torch is placed 7 cm away from a face of the specimen fixed on the holder with the composite material side of the specimen facing the torch. The torch is adjusted to produce an outer flame just touching the central point of the composite material side of the specimen that reaches and is stabilized at a desired temperature as measured using a thermometer at a point where the flame touches the specimen. An infrared (IR) thermometer or a thermocouple is used to measure the temperature at the central point of the cold side surface (i.e., the side of the specimen opposite the torch) of the sample at the designated time. According to certain embodiments, the composite material layer may have a 15-minute TE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material layer may have a 15-minute TE cold side temperature of at least about 25° C. It will be appreciated that the 15-minute TE cold side temperature of the composite material layer may be within a range between any of the values noted above. It will be further appreciated that the 15-minute TE cold side temperature of the composite material layer may be any value between any of the values noted above.

According to still other embodiments, the composite material layer may have a particular 30-minute torch exposure (TE) cold-side temperature as measured using a torch test conducted at 1300° C. for 30 minutes. For purposes of embodiments described herein, the torch test is carried out by preparing a 15 cm by 15 cm specimen of the composite material laminated onto a layer of alkaline free glass fabric having a thickness of 100 microns, such that the total specimen thickness is 1.5 mm. The specimen is fixed on a holder. A torch is placed 7 cm away from a face of the specimen fixed on the holder with the composite material side of the specimen facing the torch. The torch is adjusted to produce an outer flame just touching the central point of the composite material side of the specimen that reaches and is stabilized at a desired temperature as measured using a thermometer at a point where the flame touches the specimen. An infrared (IR) thermometer or a thermocouple is used to measure the temperature at the central point of the cold side surface (i.e., the side of the specimen opposite the torch) of the sample at the designated time. According to certain embodiments, the composite material layer may have a 30-minute TE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material layer may have a 30-minute TE cold side temperature of at least about 25° C. It will be appreciated that the 30-minute TE cold side temperature of the composite material layer may be within a range between any of the values noted above. It will be further appreciated that the 30-minute TE cold side temperature of the composite material layer may be any value between any of the values noted above.

According to yet other embodiments, the composite material layer may have a particular density. For the purpose of embodiments described herein, the density of the composite material layer may be determined according to ASTM D1056. According to certain embodiments, the composite material layer may have a density of not greater than about 1700 kg/m³, such as, not greater than about 1600 kg/m³ or not greater than about 1500 kg/m³ or not greater than about 1400 kg/m³ or not greater than about 1300 kg/m³ or not greater than about 1200 kg/m³ or not greater than about 1100 kg/m³ or not greater than about 1000 kg/m³ or not greater than about 900 kg/m³ or not greater than about 800 kg/m³ or not greater than about 700 kg/m³ or not greater than about 600 kg/m³ or not greater than about 500 kg/m³ or even not greater than about 400 kg/m³. According to yet other embodiments, the composite material layer may have a density of at least about 200 kg/m³. It will be appreciated that the density of the composite material layer may be within a range between any of the minimum and maximum values noted above. It will be further appreciated that the density of the composite material layer may be any value between any of the minimum and maximum values noted above.

According to yet other embodiments, the composite material layer may have a particular weight. According to certain embodiments, the composite material layer may have a weight of at least about 0.04 kg/m², such as, at least about 0.1 kg/m² or at least about 0.2 kg/m² or at least about 0.3 kg/m² or at least about 0.4 kg/m² or at least about 0.5 kg/m² or at least about 1.0 kg/m² or even at least about 1.5 kg/m². According to yet other embodiments, the composite material layer may have a weight of not greater than about 17 kg/m². It will be appreciated that the weight of the composite material layer may be within a range between any of the minimum and maximum values noted above. It will be further appreciated that the weight of the composite material layer may be any value between any of the minimum and maximum values noted above.

According to yet other embodiments, the composite material layer may have a particular hardness. For the purpose of embodiments described herein, the hardness of the composite material layer may be determined according to ASTM D2240. According to certain embodiments, the composite material layer may have a hardness of at least about 20 Shore. 00, such as, at least about 22 Shore. 00 or at least about 23 Shore. 00 or at least about 24 Shore. 00 or even at least about 25 Shore. 00. According to yet other embodiments, the composite material layer may have a hardness of not greater than about 71 Shore A, such as, not greater than about 70 Shore A or not greater than about 69 Shore A or not greater than about 68 Shore A or not greater than about 67 Shore A or even not greater than about 66 Shore A. It will be appreciated that the hardness of the composite material layer may be within a range between any of the minimum and maximum values noted above. It will be further appreciated that the hardness of the composite material layer may be any value between any of the minimum and maximum values noted above.

According to yet other embodiments, the composite material layer may have a particular tensile strength. For purpose of embodiments described herein, the tensile strength of the composite material layer may be determined according to ASTM D412. According to certain embodiments, the composite material layer may have a tensile strength of at least about 0.3 MPa, such as, at least about 0.5 MPa or at least about 1.0 MPa or at least about 10 MPa or at least about 20 MPa or at least about 30 MPa or at least about 40 MPa or at least about 50 MPa or at least about 100 MPa or even at least about 150 MPa. According to yet other embodiments, the composite material layer may have a tensile strength of not greater than about 500 MPa. It will be appreciated that the tensile strength of the composite material layer may be within a range between any of the minimum and maximum values noted above. It will be further appreciated that the tensile strength of the composite material layer may be any value between any of the minimum and maximum values noted above.

According to certain embodiments, composite material layers described herein may be formed according to any acceptable forming process for a composite material layer.

Turning now to additional embodiments described herein, such embodiments are generally directed to a cell vent protection composite that may include a composite material or a composite material layer as described herein. It will be appreciated that according to particular embodiments, a cell vent protection composite described herein may include any of the components described herein with reference to the composite material 100. It will be further appreciated that according to particular embodiments, a cell vent protection composite described herein may have any of the characteristics described herein with reference to the composite material 100.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A composite material comprising: a silicone-based matrix component, a reinforcing filler component distributed within the silicone-based matrix component, and a ceramization filler composition distributed within the silicone-based matrix component, wherein the ceramization filler composition comprises: a ceramization filler component, a structure promoter component, a flux component, and a flame retardant component, and wherein the composite material has a compression set of not greater than about 5% as measured at 50% compressive strain for 22 hours at 100° C.

Embodiment 2. A composite material layer comprising: a silicone-based matrix component, a reinforcing filler component distributed within the silicone-based matrix component, and a ceramization filler composition distributed within the silicone-based matrix component, wherein the ceramization filler composition comprises: a ceramization filler component, a structure promoter component, a flux component, and a flame retardant component, and wherein the composite material has a compression set of not greater than about 5% as measured at 50% compressive strain for 22 hours at 100° C.

Embodiment 3. The composite material or composite material layer of any one of embodiments 1 and 2, wherein the composite material further comprises a blowing agent component distributed within the silicone-based matrix component.

Embodiment 4. The composite material or composite material layer of embodiment 3, wherein the blowing agent composition comprises a component selected from the group consisting of 2,2′-Azobis(2-methylpropionitrile), N,N′-Dinitrosopentamethylenetetramine, N,N′-dimethyl-N,N′-dinitrosoterephthalamide, 4,4′-oxydibenzenesulfonyl hydrazide, sodium bicarbonate, and any combination thereof.

Embodiment 5. The composite material or composite material layer of any one of embodiments 1 and 2, wherein the composite material further comprises a platinum complex hydrosilylation catalyst distributed within the silicone-based matrix component.

Embodiment 6. The composite material or composite material layer of embodiment 5, wherein the composite material comprises a platinum complex hydrosilylation catalyst content of at least about 3 ppm of the composite material.

Embodiment 7. The composite material or composite material layer of embodiment 5, wherein the composite material comprises a platinum complex hydrosilylation catalyst content and not greater than about 50 ppm.

Embodiment 8. The composite material or composite material layer of any one of embodiments 1 and 2, wherein the reinforcing filler component comprises silica, silicone resin, carbon black, calcium carbonate, or any combination thereof.

Embodiment 9. The composite material or composite material layer of any one of embodiments 1 and 2, wherein the composite material comprises a reinforcing filler component content of at least about 2.0 wt. % for a total weight of the composite material.

Embodiment 10. The composite material or composite material layer of any one of embodiments 1 and 2, wherein the composite material comprises a reinforcing filler component content of not greater than about 20.0 wt. % for a total weight of the composite material.

Embodiment 11. The composite material or composite material layer of any one of embodiments 1 and 2, wherein the silicone-based matrix component comprises a polydimethylsiloxane gum having an average molecule weight between 300,000 and 800,000, or a liquid polydimethylsiloxane polymer having a viscosity of between 50 cst and 100,000 cst.

Embodiment 12. The composite material or composite material layer of any one of embodiments 1 and 2, wherein the silicone-based matrix component comprises a vinyl and Si-hydrogen group which can react with each other in the presence of a platinum catalyst.

Embodiment 13. The composite material or composite material layer of any one of embodiments 1 and 2, wherein the composite material comprises a silicone-based matrix component content of at least about 30 wt. % for a total weight of the composite material.

Embodiment 14. The composite material or composite material layer of any one of embodiments 1 and 2, wherein the composite material comprises a silicone-based matrix component content of not greater than about 60 wt. % for a total weight of the composite material.

Embodiment 15. The composite material or composite material layer of any one of embodiments 1 and 2, wherein the composite material comprises a ceramization filler composition content of at least about 40 wt. % for a total weight of the composite material.

Embodiment 16. The composite material or composite material layer of any one of embodiments 1 and 2, wherein the composite material comprises a ceramization filler composition content of not greater than about 70 wt. % for a total weight of the composite material.

Embodiment 17. The composite material or composite material layer of any one of embodiments 1 and 2, wherein the ceramization filler component comprises a component selected from the group consisting of sepiolite, wollastonite, or any combination thereof.

Embodiment 18. The composite material or composite material layer of embodiment 17, wherein the ceramization filler component has an aspect ratio (length/diameter) of not greater than about 10.

Embodiment 19. The composite material or composite material layer of embodiment 17, wherein the ceramization filler component has an aspect ratio (length/diameter) of at least about 2.

Embodiment 20. The composite material or composite material layer of any one of embodiments 1 and 2, wherein the ceramization filler composition comprises a ceramization filler component content of at least about 50 wt. % for a total weight of the ceramization filler composition.

Embodiment 21. The composite material or composite material layer of any one of embodiments 1 and 2, wherein the ceramization filler composition comprises a ceramization filler component content of not greater than about 95 wt. % for a total weight of the ceramization filler composition.

Embodiment 22. The composite material or composite material layer of any one of embodiments 1 and 2, wherein the ceramization filler composition comprises a ceramization filler component content of at least about 40 wt. % for a total weight of the composite material.

Embodiment 23. The composite material or composite material layer of any one of embodiments 1 and 2, wherein the ceramization filler composition comprises a ceramization filler component content of not greater than about 70 wt. % for a total weight of the composite material.

Embodiment 24. The composite material or composite material layer of any one of embodiments 1 and 2, wherein the structure promoter component comprises a component selected from the group consisting of crystalline silica, diopside, spodumene, lepidolite, lithium carbonate, lithium hydroxide, or any combination thereof.

Embodiment 25. The composite material or composite material layer of any one of embodiments 1 and 2, wherein the ceramization filler composition comprises a structure promoter component content of at least about 0.1 wt. % for a total weight of the ceramization filler composition.

Embodiment 26. The composite material or composite material layer of any one of embodiments 1 and 2, wherein the ceramization filler composition comprises a structure promoter component content of not greater than about 7.0 wt. % for a total weight of the ceramization filler composition.

Embodiment 27. The composite material or composite material layer of any one of embodiments 1 and 2, wherein the ceramization filler composition comprises a structure promoter component content of at least about 0.05 wt. % for a total weight of the composite material.

Embodiment 28. The composite material or composite material layer of any one of embodiments 1 and 2, wherein the ceramization filler composition comprises a structure promoter component content of not greater than about 5 wt. % for a total weight of the composite material.

Embodiment 29. The composite material or composite material layer of any one of embodiments 1 and 2, wherein the flux component comprises a component selected from the group consisting of low T glass frit, zinc oxide, zinc borate, antimony (III) oxide, bismuth trioxide, or any combination thereof.

Embodiment 30. The composite material or composite material layer of any one of embodiments 1 and 2, wherein the ceramization filler composition comprises a flux component content of at least about 0.1 wt. % for a total weight of the ceramization filler composition.

Embodiment 31. The composite material or composite material layer of any one of embodiments 1 and 2, wherein the ceramization filler composition comprises a flux component content of not greater than about 7.0 wt. % for a total weight of the ceramization filler composition.

Embodiment 32. The composite material or composite material layer of any one of embodiments 1 and 2, wherein the ceramization filler composition comprises a flux component content of at least about 0.05 wt. % for a total weight of the composite material.

Embodiment 33. The composite material or composite material layer of any one of embodiments 1 and 2, wherein the ceramization filler composition comprises a flux component content of not greater than about 5 wt. % for a total weight of the composite material.

Embodiment 34. The composite material or composite material layer of any one of embodiments 1 and 2, wherein the flame retardant component comprises a component selected from the group consisting of aluminum hydroxide, magnesium hydroxide, expanded graphite, a platinum (Pt) complex or any combination thereof.

Embodiment 35. The composite material or composite material layer of any one of embodiments 1 and 2, wherein the ceramization filler composition comprises a flame retardant component content of at least about 5.0 wt. % for a total weight of the ceramization filler composition.

Embodiment 36. The composite material or composite material layer of any one of embodiments 1 and 2, wherein the ceramization filler composition comprises a flame retardant component content of not greater than about 20.0 wt. % for a total weight of the ceramization filler composition.

Embodiment 37. The composite material or composite material layer of any one of embodiments 1 and 2, wherein the ceramization filler composition comprises a flame retardant component content of at least about 2.5 wt. % for a total weight of the composite material.

Embodiment 38. The composite material or composite material layer of any one of embodiments 1 and 2, wherein the ceramization filler composition comprises a flame retardant component content of not greater than 10 wt. % for a total weight of the composite material.

Embodiment 39. The composite material or composite material layer of any one of embodiments 1 and 2, wherein the ceramization filler composition further comprises a functional additive.

Embodiment 40. The composite material or composite material layer of embodiment 39, wherein the functional additive comprises a component selected from the group consisting of iron (III) oxide, titanium oxide, or any combination thereof.

Embodiment 41. The composite material or composite material layer of embodiment 39, wherein the ceramization filler composition comprises a functional additive content of at least about 0.1 wt. % for a total weight of the ceramization filler composition.

Embodiment 42. The composite material or composite material layer of embodiment 39, wherein the ceramization filler composition comprises a functional additive content of not greater than about 7.0 wt. % for a total weight of the ceramization filler composition.

Embodiment 43. The composite material or composite material layer of embodiment 39, wherein the ceramization filler composition comprises a functional additive content of at least about 0.05 wt. % for a total weight of the composite material.

Embodiment 44. The composite material or composite material layer of embodiment 39, wherein the ceramization filler composition comprises a functional additive content of not greater than about 5 wt. % for a total weight of the composite material.

Embodiment 45. The composite material or composite material layer of any one of embodiments 1 and 2, wherein the material layer comprises a thickness of at least about 0.2 mm.

Embodiment 46. The composite material or composite material layer of any one of embodiments 1 and 2, wherein the material layer comprises a thickness of not greater than about 3.0 mm.

Embodiment 47. The composite material or composite material layer of any one of embodiments 1 and 2, wherein the composite material comprises a density of not greater than about 1700 kg/m³.

Embodiment 48. The composite material or composite material layer of any one of embodiments 1 and 2, wherein the composite material comprises a density of at least about 200 kg/m³.

Embodiment 49. The composite material layer of embodiment 46, wherein the material layer comprises a density of not greater than about 1700 kg/m³.

Embodiment 50. The composite material layer of embodiment 46, wherein the material layer comprises wherein the layer comprises a density of at least about 200 kg/m³.

Embodiment 51. The composite material or composite material layer of any one of embodiments 1 and 2, wherein the composite material comprises a weight of at least about 0.04 kg/m².

Embodiment 52. The composite material or composite material layer of any one of embodiments 1 and 2, wherein the composite material comprises a weight of not greater than about 17 kg/m².

Embodiment 53. The composite material layer of embodiment 46, wherein the material layer comprises a weight of at least about 0.04 kg/m².

Embodiment 54. The composite material layer of embodiment 46, wherein the material layer comprises a weight of not greater than about 17 kg/m².

Embodiment 55. The composite material or composite material layer of any one of embodiments 1 and 2, wherein the composite material comprises a hardness of at least about 20 Shore.00.

Embodiment 56. The composite material or composite material layer of any one of embodiments 1 and 2, wherein the composite material comprises a hardness of not greater than about 71 Shore. A.

Embodiment 57. The composite material layer of embodiment 46, wherein the material layer comprises a hardness of at least about 20 Shore.00.

Embodiment 58. The composite material layer of embodiment 46, wherein the material layer comprises a hardness of not greater than about 71 Shore. A.

Embodiment 59. The composite material or composite material layer of any one of embodiments 1 and 2, wherein the composite material comprises a tensile strength of at least about 0.3 MPa.

Embodiment 60. The composite material or composite material layer of any one of embodiments 1 and 2, wherein the composite material comprises a tensile strength of not greater than about 500 MPa.

Embodiment 61. The composite material layer of embodiment 46, wherein the material layer comprises a tensile strength of at least about 0.3 MPa.

Embodiment 62. The composite material layer of embodiment 46, wherein the material layer comprises a tensile strength of not greater than about 500 MPa.

Embodiment 63. The composite material or composite material layer of any one of embodiments 1 and 2, wherein the composite material or composite material layer comprises a 5-minute HPE cold side temperature of not greater than about 800° C. as measured after 5 minutes of a hotplate test conducted at 800° C.

Embodiment 64. The composite material or composite material layer of any one of embodiments 1 and 2, wherein the composite material or composite material layer comprises a 15-minute HPE cold side temperature of not greater than about 800° C. as measured after 15 minutes of a hotplate test conducted at 800° C.

Embodiment 65. The composite material or composite material layer of any one of embodiments 1 and 2, wherein the composite material or composite material layer comprises a 30-minute HPE cold side temperature of not greater than about 800° C. as measured after 30 minutes of a hotplate test conducted at 800° C.

Embodiment 66. The composite material or composite material layer of any one of embodiments 1 and 2, wherein the composite material or composite material layer comprises a 5-minute TE cold side temperature of not greater than about 800° C. as measured at 5 minutes of a torch test conducted at 1300° C. with the material or composite material layer overlying a layer of glass fiber having a thickness of 100 microns.

Embodiment 67. The composite material or composite material layer of any one of embodiments 1 and 2, wherein the composite material or composite material layer comprises a 15-minute TE cold side temperature of not greater than about 800° C. as measured at 15 minutes of a torch test conducted at 1300° C. with the material or composite material layer overlying a layer of glass fiber having a thickness of 100 microns.

Embodiment 68. The composite material or composite material layer of any one of embodiments 1 and 2, wherein the composite material or composite material layer comprises a 30-minute TE cold side temperature of not greater than about 800° C. as measured at 30 minutes of a torch test conducted at 1300° C. with the material or composite material layer overlying a layer of glass fiber having a thickness of 100 microns.

Embodiment 69. The composite material or composite material layer of any one of embodiments 1 and 2, wherein the composite material or composite material layer comprises a V-0 flammability rating as measured according to ASTM D3801.

Embodiment 70. The composite material or composite material layer of any one of embodiments 1 and 2, wherein the composite material or composite material layer comprises a thermal conductivity of not greater than about 0.20 W/mk.

Embodiment 71. A cell vent protection composite material comprising: a silicone-based matrix component, a reinforcing filler component distributed within the silicone-based matrix component, and a ceramization filler composition distributed within the silicone-based matrix component, wherein the ceramization filler composition comprises: a ceramization filler component, a structure promoter component, a flux component, and a flame retardant component, and wherein the composite material has a compression set of not greater than about 5% as measured at 50% compressive strain for 22 hours at 100° C.

Embodiment 72. A cell vent protection composite material layer comprising: a silicone-based matrix component, a reinforcing filler component distributed within the silicone-based matrix component, and a ceramization filler composition distributed within the silicone-based matrix component, wherein the ceramization filler composition comprises: a ceramization filler component, a structure promoter component, a flux component, and a flame retardant component, and wherein the composite material has a compression set of not greater than about 5% as measured at 50% compressive strain for 22 hours at 100° C.

Embodiment 73. The cell vent protection composite material or composite material layer of any one of embodiments 71 and 72, wherein the composite material further comprises a blowing agent component distributed within the silicone-based matrix component.

Embodiment 74. The cell vent protection composite material or composite material layer of embodiment 73, wherein the blowing agent composition comprises a component selected from the group consisting of 2,2′-Azobis(2-methylpropionitrile), N,N′-Dinitrosopentamethylenetetramine, N,N′-dimethyl-N,N′-dinitrosoterephthalamide, 4,4′-oxydibenzenesulfonyl hydrazide, sodium bicarbonate, and any combination thereof.

Embodiment 75. The cell vent protection composite material or composite material layer of any one of embodiments 71 and 72, wherein the composite material further comprises a platinum complex hydrosilylation catalyst distributed within the silicone-based matrix component.

Embodiment 76. The cell vent protection composite material or composite material layer of embodiment 75, wherein the composite material comprises a platinum complex hydrosilylation catalyst content of at least about 3 ppm of the composite material.

Embodiment 77. The cell vent protection composite material or composite material layer of embodiment 75, wherein the composite material comprises a platinum complex hydrosilylation catalyst content and not greater than about 50 ppm.

Embodiment 78. The cell vent protection composite material or composite material layer of any one of embodiments 71 and 72, wherein the reinforcing filler component comprises silica, silicone resin, carbon black, calcium carbonate, or any combination thereof.

Embodiment 79. The cell vent protection composite material or composite material layer of any one of embodiments 71 and 72, wherein the composite material comprises a reinforcing filler component content of at least about 2.0 wt. % for a total weight of the composite material.

Embodiment 80. The cell vent protection composite material or composite material layer of any one of embodiments 71 and 72, wherein the composite material comprises a reinforcing filler component content of not greater than about 20.0 wt. % for a total weight of the composite material.

Embodiment 81. The cell vent protection composite material or composite material layer of any one of embodiments 71 and 72, wherein the silicone-based matrix component comprises a polydimethylsiloxane gum having an average molecule weight between 300,000 and 800,000, or a liquid polydimethylsiloxane polymer having a viscosity of between 50 cst and 100,000 cst.

Embodiment 82. The cell vent protection composite material or composite material layer of any one of embodiments 71 and 72, wherein the silicone-based matrix component comprises a vinyl and Si-hydrogen group which can react with each other in the presence of a platinum catalyst.

Embodiment 83. The cell vent protection composite material or composite material layer of any one of embodiments 71 and 72, wherein the composite material comprises a silicone-based matrix component content of at least about 30 wt. % for a total weight of the composite material.

Embodiment 84. The cell vent protection composite material or composite material layer of any one of embodiments 71 and 72, wherein the composite material comprises a silicone-based matrix component content of not greater than about 60 wt. % for a total weight of the composite material.

Embodiment 85. The cell vent protection composite material or composite material layer of any one of embodiments 71 and 72, wherein the composite material comprises a ceramization filler composition content of at least about 40 wt. % for a total weight of the composite material.

Embodiment 86. The cell vent protection composite material or composite material layer of any one of embodiments 71 and 72, wherein the composite material comprises a ceramization filler composition content of not greater than about 70 wt. % for a total weight of the composite material.

Embodiment 87. The cell vent protection composite material or composite material layer of any one of embodiments 71 and 72, wherein the ceramization filler component comprises a component selected from the group consisting of sepiolite, wollastonite, or any combination thereof.

Embodiment 88. The cell vent protection composite material or composite material layer of embodiment 87, wherein the ceramization filler component has an aspect ratio (length/diameter) of not greater than about 10.

Embodiment 89. The cell vent protection composite material or composite material layer of embodiment 87, wherein the ceramization filler component has an aspect ratio (length/diameter) of at least about 2.

Embodiment 90. The cell vent protection composite material or composite material layer of any one of embodiments 71 and 72, wherein the ceramization filler composition comprises a ceramization filler component content of at least about 50 wt. % for a total weight of the ceramization filler composition.

Embodiment 91. The cell vent protection composite material or composite material layer of any one of embodiments 71 and 72, wherein the ceramization filler composition comprises a ceramization filler component content of not greater than about 95 wt. % for a total weight of the ceramization filler composition.

Embodiment 92. The cell vent protection composite material or composite material layer of any one of embodiments 71 and 72, wherein the ceramization filler composition comprises a ceramization filler component content of at least about 40 wt. % for a total weight of the composite material.

Embodiment 93. The cell vent protection composite material or composite material layer of any one of embodiments 71 and 72, wherein the ceramization filler composition comprises a ceramization filler component content of not greater than about 70 wt. % for a total weight of the composite material.

Embodiment 94. The cell vent protection composite material or composite material layer of any one of embodiments 71 and 72, wherein the structure promoter component comprises a component selected from the group consisting of crystalline silica, diopside, spodumene, lepidolite, lithium carbonate, lithium hydroxide, or any combination thereof.

Embodiment 95. The cell vent protection composite material or composite material layer of any one of embodiments 71 and 72, wherein the ceramization filler composition comprises a structure promoter component content of at least about 0.1 wt. % for a total weight of the ceramization filler composition.

Embodiment 96. The cell vent protection composite material or composite material layer of any one of embodiments 71 and 72, wherein the ceramization filler composition comprises a structure promoter component content of not greater than about 7.0 wt. % for a total weight of the ceramization filler composition.

Embodiment 97. The cell vent protection composite material or composite material layer of any one of embodiments 71 and 72, wherein the ceramization filler composition comprises a structure promoter component content of at least about 0.05 wt. % for a total weight of the composite material.

Embodiment 98. The cell vent protection composite material or composite material layer of any one of embodiments 71 and 72, wherein the ceramization filler composition comprises a structure promoter component content of not greater than about 5 wt. % for a total weight of the composite material.

Embodiment 99. The cell vent protection composite material or composite material layer of any one of embodiments 71 and 72, wherein the flux component comprises a component selected from the group consisting of low T glass frit, zinc oxide, zinc borate, antimony (III) oxide, bismuth trioxide, or any combination thereof.

Embodiment 100. The cell vent protection composite material or composite material layer of any one of embodiments 71 and 72, wherein the ceramization filler composition comprises a flux component content of at least about 0.1 wt. % for a total weight of the ceramization filler composition.

Embodiment 101. The cell vent protection composite material or composite material layer of any one of embodiments 71 and 72, wherein the ceramization filler composition comprises a flux component content of not greater than about 7.0 wt. % for a total weight of the ceramization filler composition.

Embodiment 102. The cell vent protection composite material or composite material layer of any one of embodiments 71 and 72, wherein the ceramization filler composition comprises a flux component content of at least about 0.05 wt. % for a total weight of the composite material.

Embodiment 103. The cell vent protection composite material or composite material layer of any one of embodiments 71 and 72, wherein the ceramization filler composition comprises a flux component content of not greater than about 5 wt. % for a total weight of the composite material.

Embodiment 104. The cell vent protection composite material or composite material layer of any one of embodiments 71 and 72, wherein the flame retardant component comprises a component selected from the group consisting of aluminum hydroxide, magnesium hydroxide, expanded graphite, a platinum (Pt) complex or any combination thereof.

Embodiment 105. The cell vent protection composite material or composite material layer of any one of embodiments 71 and 72, wherein the ceramization filler composition comprises a flame retardant component content of at least about 5.0 wt. % for a total weight of the ceramization filler composition.

Embodiment 106. The cell vent protection composite material or composite material layer of any one of embodiments 71 and 72, wherein the ceramization filler composition comprises a flame retardant component content of not greater than about 20.0 wt. % for a total weight of the ceramization filler composition.

Embodiment 107. The cell vent protection composite material or composite material layer of any one of embodiments 71 and 72, wherein the ceramization filler composition comprises a flame retardant component content of at least about 2.5 wt. % for a total weight of the composite material.

Embodiment 108. The cell vent protection composite material or composite material layer of any one of embodiments 71 and 72, wherein the ceramization filler composition comprises a flame retardant component content of not greater than 10 wt. % for a total weight of the composite material.

Embodiment 109. The cell vent protection composite material or composite material layer of any one of embodiments 71 and 72, wherein the ceramization filler composition further comprises a functional additive.

Embodiment 110. The cell vent protection composite material or composite material layer of embodiment 109, wherein the functional additive comprises a component selected from the group consisting of iron (III) oxide, titanium oxide, or any combination thereof.

Embodiment 111. The cell vent protection composite material or composite material layer of embodiment 109, wherein the ceramization filler composition comprises a functional additive content of at least about 0.1 wt. % for a total weight of the ceramization filler composition.

Embodiment 112. The cell vent protection composite material or composite material layer of embodiment 109, wherein the ceramization filler composition comprises a functional additive content of not greater than about 7.0 wt. % for a total weight of the ceramization filler composition.

Embodiment 113. The cell vent protection composite material or composite material layer of embodiment 109, wherein the ceramization filler composition comprises a functional additive content of at least about 0.05 wt. % for a total weight of the composite material.

Embodiment 114. The cell vent protection composite material or composite material layer of embodiment 109, wherein the ceramization filler composition comprises a functional additive content of not greater than about 5 wt. % for a total weight of the composite material.

Embodiment 115. The cell vent protection composite material or composite material layer of any one of embodiments 71 and 72, wherein the material layer comprises a thickness of at least about 0.2 mm.

Embodiment 116. The cell vent protection composite material or composite material layer of any one of embodiments 71 and 72, wherein the material layer comprises a thickness of not greater than about 3.0 mm.

Embodiment 117. The cell vent protection composite material layer of embodiment 71, wherein the composite material comprises a density of not greater than about 1700 kg/m³.

Embodiment 118. The cell vent protection composite material layer of embodiment 71, wherein the composite material comprises wherein the foam layer comprises a density of at least about 200 kg/m³.

Embodiment 119. The cell vent protection composite material layer of embodiment 72, wherein the material layer comprises a density of not greater than about 1700 kg/m³.

Embodiment 120. The cell vent protection composite material layer of embodiment 72, wherein the material layer comprises wherein the layer comprises a density of at least about 200 kg/m³.

Embodiment 121. The cell vent protection composite material layer of embodiment 71, wherein the composite material comprises a weight of at least about 0.04 kg/m².

Embodiment 122. The cell vent protection composite material layer of embodiment 71, wherein the composite material comprises a weight of not greater than about 17 kg/m².

Embodiment 123. The cell vent protection composite material layer of embodiment 72, wherein the material layer comprises a weight of at least about 0.04 kg/m².

Embodiment 124. The cell vent protection composite material layer of embodiment 72, wherein the material layer comprises a weight of not greater than about 17 kg/m².

Embodiment 125. The cell vent protection composite material layer of embodiment 71, wherein the composite material comprises a hardness of at least about 20 Shore.00.

Embodiment 126. The cell vent protection composite material layer of embodiment 71, wherein the composite material comprises a hardness of not greater than about 71 Shore. A.

Embodiment 127. The cell vent protection composite material layer of embodiment 72, wherein the material layer comprises a hardness of at least about 20 Shore.00.

Embodiment 128. The cell vent protection composite material layer of embodiment 72, wherein the material layer comprises a hardness of not greater than about 71 Shore. A.

Embodiment 129. The cell vent protection composite material layer of embodiment 71, wherein the composite material comprises a tensile strength of at least about 0.3 MPa.

Embodiment 130. The cell vent protection composite material layer of embodiment 71, wherein the composite material comprises a tensile strength of not greater than about 500 MPa.

Embodiment 131. The cell vent protection composite material layer of embodiment 72, wherein the material layer comprises a tensile strength of at least about 0.3 MPa.

Embodiment 132. The cell vent protection composite material layer of embodiment 72, wherein the material layer comprises a tensile strength of not greater than about 500 MPa.

Embodiment 133. The cell vent protection composite material or composite material layer of any one of embodiments 71 and 72, wherein the cell vent protection composite material or composite material layer comprises a 5-minute HPE cold side temperature of not greater than about 800° C. as measured after 5 minutes of a hotplate test conducted at 800° C.

Embodiment 134. The cell vent protection composite material or composite material layer of any one of embodiments 71 and 72, wherein the cell vent protection composite material or composite material layer comprises a 15-minute HPE cold side temperature of not greater than about 800° C. as measured after 15 minutes of a hotplate test conducted at 800° C.

Embodiment 135. The cell vent protection composite material or composite material layer of any one of embodiments 71 and 72, wherein the cell vent protection composite material or composite material layer comprises a 30-minute HPE cold side temperature of not greater than about 800° C. as measured after 30 minutes of a hotplate test conducted at 800° C.

Embodiment 136. The cell vent protection composite material or composite material layer of any one of embodiments 71 and 72, wherein the cell vent protection composite material or composite material layer comprises a 5-minute TE cold side temperature of not greater than about 800° C. as measured at 5 minutes of a torch test conducted at 1300° C. with the material or composite material layer overlying a layer of glass fiber having a thickness of 100 microns.

Embodiment 137. The cell vent protection composite material or composite material layer of any one of embodiments 71 and 72, wherein the cell vent protection composite material or composite material layer comprises a 15-minute TE cold side temperature of not greater than about 800° C. as measured at 15 minutes of a torch test conducted at 1300° C. with the material or composite material layer overlying a layer of glass fiber having a thickness of 100 microns.

Embodiment 138. The cell vent protection composite material or composite material layer of any one of embodiments 71 and 72, wherein the cell vent protection composite material or composite material layer comprises a 30-minute TE cold side temperature of not greater than about 800° C. as measured at 30 minutes of a torch test conducted at 1300° C. with the material or composite material layer overlying a layer of glass fiber having a thickness of 100 microns.

Embodiment 139. The cell vent protection composite material or composite material layer of any one of embodiments 71 and 72, wherein the cell vent protection composite material or composite material layer comprises a V-0 flammability rating as measured according to ASTM D3801.

Embodiment 140. The cell vent protection composite material or composite material layer of any one of embodiments 71 and 72, wherein the composite material or composite material layer comprises a thermal conductivity of not greater than about 0.20 W/mk.

Note that not all of the activities described above in the general description, or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A composite material comprising:
a silicone-based matrix component,
a reinforcing filler component distributed within the silicone-based matrix component, and
a ceramization filler composition distributed within the silicone-based matrix component,
wherein the ceramization filler composition comprises:
a ceramization filler component,
a structure promoter component,
a flux component, and
a flame retardant component, and
wherein the composite material has a compression set of not greater than about 5% as measured at 50% compressive strain for 22 hours at 100° C.

2. The composite material of claim 1, wherein the composite material further comprises a blowing agent component distributed within the silicone-based matrix component.

3. The composite material of claim 2, wherein the blowing agent composition comprises a component selected from the group consisting of 2,2′-Azobis(2-methylpropionitrile), N,N′-Dinitrosopentamethylenetetramine, N,N′-dimethyl-N,N′-dinitrosoterephthalamide, 4,4′-oxydibenzenesulfonyl hydrazide, sodium bicarbonate, and any combination thereof.

4. The composite material of claim 1, wherein the composite material further comprises a platinum complex hydrosilylation catalyst distributed within the silicone-based matrix component.

5. The composite material of claim 4, wherein the composite material comprises a platinum complex hydrosilylation catalyst content of at least about 3 ppm of the composite material.

6. The composite material of claim 4, wherein the composite material comprises a platinum complex hydrosilylation catalyst content and not greater than about 50 ppm.

7. The composite material of claim 1, wherein the reinforcing filler component comprises silica, silicone resin, carbon black, calcium carbonate, or any combination thereof.

8. The composite material of claim 1, wherein the composite material comprises a reinforcing filler component content of at least about 2.0 wt. % for a total weight of the composite material.

9. The composite material of claim 1, wherein the composite material comprises a reinforcing filler component content of not greater than about 20.0 wt. % for a total weight of the composite material.

10. The composite material of claim 1, wherein the silicone-based matrix component comprises a polydimethylsiloxane gum having an average molecule weight between 300,000 and 800,000, or a liquid polydimethylsiloxane polymer having a viscosity of between 50 cst and 100,000 cst.

11. The composite material of claim 1, wherein the silicone-based matrix component comprises a vinyl and Si-hydrogen group which can react with each other in the presence of a platinum catalyst.

12. The composite material of claim 1, wherein the composite material comprises a silicone-based matrix component content of at least about 30 wt. % for a total weight of the composite material.

13. The composite material of claim 1, wherein the composite material comprises a silicone-based matrix component content of not greater than about 60 wt. % for a total weight of the composite material.

14. The composite material of claim 1, wherein the composite material comprises a ceramization filler composition content of at least about 40 wt. % for a total weight of the composite material.

15. A composite material layer comprising:
a silicone-based matrix component,
a reinforcing filler component distributed within the silicone-based matrix component, and
a ceramization filler composition distributed within the silicone-based matrix component,
wherein the ceramization filler composition comprises:
a ceramization filler component,
a structure promoter component,
a flux component, and
a flame retardant component, and
wherein the composite material has a compression set of not greater than about 5% as measured at 50% compressive strain for 22 hours at 100° C.

16. The composite material layer of claim 15, wherein the composite material further comprises a blowing agent component distributed within the silicone-based matrix component.

17. The composite material layer of claim 16, wherein the blowing agent composition comprises a component selected from the group consisting of 2,2′-Azobis(2-methylpropionitrile), N,N′-Dinitrosopentamethylenetetramine, N,N′-dimethyl-N,N′-dinitrosoterephthalamide, 4,4′-oxydibenzenesulfonyl hydrazide, sodium bicarbonate, and any combination thereof.

18. The composite material layer of claim 15, wherein the composite material further comprises a platinum complex hydrosilylation catalyst distributed within the silicone-based matrix component.

19. The composite material layer of claim 18, wherein the composite material comprises a platinum complex hydrosilylation catalyst content of at least about 3 ppm of the composite material.

20. The composite material layer of claim 18, wherein the composite material comprises a platinum complex hydrosilylation catalyst content and not greater than about 50 ppm.
